(19) United States
(12) Patent Application Publication
(10) Pub. No.: US 2011/0275519 A1
(43) Pub. Date: Nov. 10, 2011

(54) Pesticidal Dispersion Comprising Nanostructured Dispersed Phase

(76) Inventors: Otto GLATTER, Graz (AT); Sandra Engelskirchen, Stuttgart (DE); Tatjana Levy, Mannheim (DE); Helmut Auweter, Limburgerhof (DE); Rainer Berghaus, Speyer (DE); Siegfried Strathmann, Limburgerhof (DE)

(21) Appl. No.: 13/100,638

(22) Filed: May 4, 2011

Related U.S. Application Data
(60) Provisional application No. 61/331,846, filed on May 6, 2010.

(51) Int. Cl. A01N 43/84; A01P 21/00; A01P 15/00; A01N 43/56; A01N 43/54

(52) U.S. Cl. 504/224; 514/404; 514/239.5; 514/399; 504/280; 504/279

(57) ABSTRACT

The present invention relates to a dispersion containing an aqueous continuous phase and a dispersed phase, wherein the dispersed phase exhibits a nano-sized self-assembled structurization and wherein the dispersed phase contains a pesticide with a water solubility at 25° C. of up to 10 g/l and a melting point of below 100° C. The present invention further relates to a method for preparing said dispersion comprising a step of contacting the components, and to a method for controlling phytopathogenic fungi and/or undesired plant growth and/or undesired attack by insects or mites and/or for regulating the growth of plants, where said dispersion is allowed to act on the particular pests, their habitat or the plants to be protected from the particular pest, the soil and/or on undesired plants and/or the useful plants and/or their habitat.

The present invention relates to a dispersion containing an aqueous continuous phase and a dispersed phase, wherein the dispersed phase exhibits a nano-sized self-assembled structurization and wherein the dispersed phase contains a pesticide with a water solubility at 25° C. of up to 10 g/l and a melting point of below 100° C. The present invention further relates to a method for preparing said dispersion comprising a step of contacting the components, and to a method for controlling phytopathogenic fungi and/or undesired plant growth and/or undesired attack by insects or mites and/or for regulating the growth of plants, where said dispersion is allowed to act on the particular pests, their habitat or the plants to be protected from the particular pest, the soil and/or on undesired plants and/or the useful plants and/or their habitat. Combinations of preferred embodiments with other preferred embodiments are within the scope of the present invention.

A dispersion containing an aqueous continuous phase and a dispersed phase, wherein the dispersed phase exhibits a nano-sized self-assembled structurization, are well known:

Yaghmur and Glatter (“Characterization and potential applications of nanostructured aqueous dispersion”, Adv. Colloid Interface Sci. 2009, 147-148, 333-342) review in detail recent advances in characerization and utilization of the aforementioned dispersions.

Kaasgard and Drummond (“Ordered 2-D and 3-D nanostructred amphiphile self-assembly materials stable in excess solvent”, Phys. Chem. Chemm. Phys. 2006, 8, 4957-4975) review the structures and amphiphils for the preparation of the aforementioned dispersions.

WO 2007/060177 discloses an oil-in-water emulsion wherein the oil droplets of a diameter in the range of 5 nm to hundreds of micrometers exhibit a nano-sized self-assembled structurization with hydrophilic domains having a diameter size in the range of 0.5 to 200 nm, due to the presence of a lipophilic additive and the oil-in-water emulsion contains an active element being present in the range comprised between 0.00001 and 79% based on the total composition. Said active element may be for example chemicals for agrochemical applications.

WO 2007/060171 discloses the use of a lipidic phase comprising an oil and a lipophilic additive (LPA), wherein the LPA content in the lipidic phase is comprised between 0.25 wt % and 84 wt %, for preparing an oil-in-water emulsion wherein the mixing of the lipidic phase and the aqueous phase containing an emulsifier is made by using a manual operation or a low energy device.

EP 1 597 973 and EP 1 598 060 disclose an oil-in-water emulsion wherein the oil droplets of a diameter in the range of 5 nm to hundreds of micrometers exhibit a nano-sized structurisation with hydrophilic domains with a diameter size in the range of 0.5 to 50 nm and being formed by a lipophilic additive.

Object of the present invention was to find an aqueous based formulation of pesticides which overcomes the drawbacks of the state of the art. Another object was to find a formulation comprising a low amount of organic solvent, allowing a high loading with pesticide, being stable on storage or on dilution with water.

The object was solved by a dispersion containing an aqueous continuous phase and a dispersed phase, wherein the dispersed phase exhibits a nano-sized self-assembled structurization and wherein the dispersed phase contains a pesticide with a water solubility at 25° C. of up to 10 g/l and a melting point of below 100° C.

The dispersed phase exhibiting the nano-sized self-assembled structurization may be determined by known methods, e.g. small angle X-ray scattering (SAXS), cryo-transmission electron microscopy (Cryo-TEM) and ¹³C-NMR.

Preferably, the nano-sized self-assembled structurization has a signal in SAXS. It is well known, that the shape of the signal, its intensity and the pattern of shapes depends on the nano-sized structurization. Typical structurization types (such as “emulsified L2-phase”, “micellar cubosomes”, “hexosomes”, “cubosomes”) and resulting SAXS signals are for example reviewed by Yaghmur and Glatter, Adv. Colloid Interface Sci. 2009, 147-148, 333-342 (especially FIG. 4, 6, 9).

The dispersed phase usually comprises water, pesticide, amphiphile and optionally adjuvant. The dispersed phase preferably consists of water, pesticide, amphiphile and optionally adjuvant.

Usually, the dispersed phase contains less than 15 wt %, preferably less than 5 wt %, more preferably less than 1 wt %, and especially less than 0.1 wt % of an oil. The term oil relates to mineral oils, hydrocarbons (e.g. aliphatic, alicyclic, aromatic hydrocarbons), fatty acids, vegetable oils, fats, waxes, essential oils, flavouring oils. Preferably, the term oil relates to mineral oils and hydrocarbons.

Usually, the dispersed phase contains less than 15 wt %, preferably less than 5 wt %, more preferably less than 1 wt %, and especially less than 0.1 wt % of an oil-soluble solvent. Typically, the oil-soluble solvent may dissolve the pesticide in an amount of at least 50 g/l at 20° C. The oil-soluble solvent is usually soluble in toluene of at least 50 g/l at 20° C.

The term oil-soluble solvent relates to solvents, which have a solubility in water of less than 10 g/l, preferably less than 1 g/l and especially less than 0.1 g/l. Suitable oil-soluble solvents are organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives.

The hydrodynamic radius (R_{H}) of the dispersed phase is usually in a range from 10 nm to 2.0 μm, preferably in a range from 20 to 1000 nm, more preferably from 50 to 800 nm, as determined by dynamic light scattering.

The aqueous continuous phase comprises typically water and stabilizing surfactant. In addition further components may be present, such a thickener, further pesticides, an anti-freezing agent, water-soluble adjuvants or other common auxiliaries.

Amphiphiles, which are suitable for use in the dispersed phase, which exhibits a nanosized self-assembled structurization, are well known. Suitable amphiphiles are listed by Kaasgard and Drummond (Phys. Chem. Chem. Phys. 2006, 8, 4957-4975) on page 4961-4972 under the headings ethylene oxide amphiphiles, monoacylglacerols, glycolipids, phosphatidylethanolamine amphiphiles and urea amphiphiles, or by WO 2005/014163, page 19, last paragraph to page 23, first paragraph.

Typically, the amphiphile have a solubility in water at 20° C. of up to 10 wt %, preferably of up to 3 wt %, more preferably of up to 1 wt % and especially of up to 0.1 wt %.

Preferred amphiphile are amphiphilic lipids, polyethylene oxide amphiphiles, and/or urea-based amphiphiles. More preferred amphiphiles are amphiphilic lipids. Mixtures of different amphiphiles are also suitable.

Examples for amphiphile lipids are
glycerides (e.g. monoglycerides, diglycerides, and triglycerides),
di- and polyglycerolesters of glycerides (e.g. diglycerol monooleate, diglycerol monocaprate),
transesterification products of oils and PEG (e.g. ethoxylated castor oil (e.g. Cremophor EL (BASF)),
ethoxylated hydrogenated castor oil (e.g. Cremophor® RH-40 (BASF)),
ethoxylated corn oil (e.g. Labrafil® M 2125 CS (Gattefossé)),
acetylated monoglycerides,
fatty alcohols (e.g. phytantriol (3,7,11,15-tetramethyl-1,2,3-hexadecantriol)),
ether lipids (e.g. monooleyl glyceryl ether),
natural and synthetic phospholipids (e.g. egg lecithin, soya lecithin, hydrogenated lecithin, phosphatidyl choline, phosphatidyl ethanolamine, phosphatidyl serine, phosphatidyl glycerol, phosphatidic acid),
lysophospholipids (e.g. lyso-lecithin, lyso-phosphatidyl choline, lyso-oleyl phosphatidyl choline),
phospholipid-analogous compounds (e.g. those disclosed in U.S. Pat. No. 6,344,576),
sterols and sterol derivatives (e.g. cholesterol, sitosterol, lanesterol and their esters, especially with PEG or fatty acids),
galactolipids (e.g. digalactosyl diacylglycerol, monogalactosyl diacylglycerol),
sphingolipids (e.g. sphingomyelin);
fatty acid salts,
succinylated monoglycerides,
mono/diacetylated tartaric acid esters of mono- and diglycerides,
citric acid esters of mono- and diglycerides,
glyceryl-lacto esters of fatty acids.

Examples for polyethylene oxide amphiphiles are
ethoxylated surfactants such as PEG-fatty acid mono- and diesters (e.g. of the Crodet (Croda), Cithrol® (Croda), Nikkol® (Nikko), Myrj (101) series, Solutol® HS 15 (BASF)),
PEG glycerol fatty acid esters (e.g. Tagat® L and O (Goldschmidt), Glycerox® L series (Croda), Capmul® EMG (Abitec)),
transesterification products of oils and PEG (e.g. of the Labrafil® (Gattefosse), Cremophor® (BASF) Crovol® (Croda) and Nikko HCO (Nikko) series),
PEG-sorbitan fatty acid esters (e.g. Tween® 20, Tween® 80 and other polysorbates of the Tween® series (ICI)),
PEG alkyl esters (e.g. of the Brij® (ICI) and Volpo (Croda) series),
PEG alkyl phenol surfactants (e.g. of the Triton X and N series (Rohm & Haas);
polyglycerised fatty acids (e.g. Nikkol® Decaglyn (Nikko), PluroIX Oleique (Gattefosse)),
propylene glycol fatty acid esters (e.g. Capryl® 90 (Gattefosse), Lutrol OP2000 (BASF), Captez (Abitec)),
glycerol/propylene glycol fatty acid esters (e.g. Arlacel® 186 (101)),
sorbitan fatty acid esters (e.g. of the Span® (ICI) and Crill® (Croda) series),
sugar esters (e.g. of the SUCRO ESTER® (Gattefosse) and Crodesta (Croda) series),
polyoxyethylene-polyoxypropylene block copolymers (so-called poloxamers, e.g. of the Pluronic® (BASF), Synperonic (101) and Lutrol0 (BASF) series),
copolymers of ethylene oxide and butylene oxide;
ethoxylated amines (e.g. polyoxyethylene-15 coconut amine).

Examples for urea-based amphiphiles are C₈ to C₂₂ alkylurea, e.g. dodecylurea, octadecylurea, oleylurea, oleylbiuret, phytanylurea, hexafarnesylurea.

The most preferred amphiphiles are glycerol and diglycerol monooleate and monolinoleate, glyceoldioleate (GDO), dioleyl phosphatidyl ethanolamine (DOPE), dioleyl phosphatidylcholine (DOPC) and phytantriol, and mixtures of these with up to 50% fatty acids, in particular oleic acid and linoleic acid, polysorbate 80 (Tween 80), polyethylene glycol 660 12-hydroxysterate (Solutol® HS 15), or lysophospholipids, especially lysooleyl phosphatidylcholine (LOPC). Especiylly preferred amphiphiles are glycerol monolinoleate (also known as 1-monolinolein) and phytantriol.

Often the amphiphile will contain components in the form of extracted and purified natural products and will thus contain a mixture of related compounds. Soy bean phosphatidyl choline, for example is a mixture of compounds having around 60-75% C18:2 acyl groups, around 12-16% C16:0 and the balance others. Similarly, commercial glycerol monooleate (GMO) or commercial glycerol monolinoleate is typically at least 90% monoglyceride but contains small amounts of diglyceride and free fatty acid. For example, the acyl groups of GMO are usually over 60-90% C18:1, 5-10% saturated and the remainder largely higher unsaturated acyl groups. For example, the acyl groups of 1-monolinolein are usually over 60-90% C18:2, 5-10% saturated and the remainder largely higher unsaturated acyl groups. As indicated above, this is largely monoglyceride with an oleoyl or linolein acyl chain but contains certain amounts of other compounds. These are included in the term GMO or monolinoleate as used herein. Commercial preparations of GMO include GMOrphic-80 and Myverol 18-99 (available from Eastman Kodak), Rylo MG 19 and Dimodan DGMO (available from Danisco).

Suitable stabilizing surfactants include anionic, cationic, nonionic and amphoteric surfactants, block polymers and polyelectrolytes. Further on, polysaccharide (e.g. starch, starch derivatives, celloluse derivatives, xanthan gum, gelatin) may be used as stabilizing surfactants. Preferred stabilizing surfactans are nonionic surfactants (preferably alkoxylates, such as comb polymers) and/or block polymers. Mixtures of aforementioned stabilizing surfactants are also suitable.

Typically stabilizing surfactants have an HLB of at least 12, preferably at least 14.

The solubility in water at 20° C. of the stabilizing surfactant is usually at least 5 wt %, preferably at least 10 wt %, more preferably at least 20 wt %, and especially at least 30 wt %.

Suitable anionic surfactants are alkali, alkaline earth or ammonium salts of sulfonates, sulfates, phosphates or carboxylates. Examples of sulfonates are alkylarylsulfonates, diphenylsulfonates, alpha-olefin sulfonates, sulfonates of fatty acids and oils, sulfonates of ethoxylated alkylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Suitable nonionic surfactants are alkoxylates, N-alkylated fatty acid amides, amine oxides, esters or sugar-based surfactants. Examples of alkoxylates are compounds such as alcohols, alkylphenols, amines, amides, arylphenols, fatty acids or fatty acid esters which have been alkoxylated. Ethylene oxide and/or propylene oxide may be employed for the alkoxylation, preferably ethylene oxide. Examples of N-alkylated fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Further alkoxylates are comb polymers comprising polyethylene glycol, such as comb polymers comprising polyethylene glycol (meth)acrylate. Preferred comb polymers are those made of methacrylic acid, methyl methacrylate and methoxy polyethylene glycol methacrylate (e.g. Atlox® 4913, commercially available Croda).

Examples of suitable cationic surfactants are quaternary surfactants, for example quaternary ammonium compounds with one or two hydrophobic groups, or salts of long-chain primary amines. Suitable amphoteric surfactants are alkylbetains and imidazolines.

Suitable block polymers are block polymers of the A-B or A-B-A type comprising blocks of polyethylene oxide and polypropylene oxide or of the A-B-C type comprising alkanol, polyethylene oxide and polypropylene oxide. Further suitable block copolymers are poloxamers, which comprise at least one block of polyoxyethylene and at least one block of polyoxypropylene. Examples are poloxamer 407 (e.g. Pluronic F127, BASF), poloxamer 188 (e.g. PluronicE F68, BASF), poloxamer 124 (PluronicX L44, BASF), and polysorbates 20, 60 and/or 80 (referred to herein a P20, P60 & P80 respectively e.g. Tween® 80, ICI). Preferred block polymers are those comprising blocks of polyethylene oxide and polypropylene oxide, such as poloxamer 407.

Suitable polyelectrolytes are polyacids or polybases. Examples of polyacids are alkali salts of polyacrylic acid. Examples of polybases are polyvinylamines or polyethyleneamines.

The term pesticide refers to at least one active substance selected from the group of the fungicides, insecticides, nematicides, herbicides, safeners and/or growth regulators. Preferred pesticides are fungicides, insecticides, herbicides and growth regulators. Mixtures of pesticides of two or more of the abovementioned classes may also be used. The skilled worker is familiar with such pesticides, which can be found, for example, in the Pesticide Manual, 14th Ed. (2006), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds nereistoxin analogs, benzoylureas, diacylhydrazines, and METI acarizides. Suitable fungicides are fungicides from the classes of dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid diamides, chloronitriles cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino)pyrimidines, hydroxyanilides, imidazoles, imidazolinones, inorganic substances, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of the acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

The pesticide has a water solubility at 25° C. of up to 10 g/l, preferably of up to 1 g/l, more preferably of up to 0.2 g/l and especially of up to 0.05 g/l.

The pesticide has a melting point of below 100° C., preferably below 90° C., more preferably below 80° C., especially below 70° C. and most preferred below 60° C.

Adjuvants are a well known class of compounds, which increase the efficacy of a pesticide. Examples may be found in WO 2004/017734, page 2, line 13 to page 3, line 27. Suitable adjuvants are organic modified polysiloxanes such as Break Thru S 240®; alcohol alkoxylates such as Atplus 245®, Atplus MBA 1303®, Plurafac LF 300® and Lutensol ON 30®; EO/PO block polymers, e.g. Pluronic RPE 2035® and Genapol B®; alcohol ethoxylates such as Lutensol XP 80®; and dioctyl sulfosuccinate sodium such as Leophen RA®. The solubility in water at 20° C. of the adjuvant is usually up to 50 g/l, preferably up to 5 g/l, more preferably up to 0.5 g/l.

The dispersion according to the invention may also comprise auxiliaries which are customary in agrochemical compositions. Preferably, these auxiliaries are present in the continuous phase of the dispersion. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations). Such auxiliaries may be present either in the aqueous continuous phase of the dispersed phase or in both phases, depending on the solubility of the auxiliaries.

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as N-methylpyrrolidone. Preferred solvent are water, and water comprising up to 30 wt % (preferably up to 10 wt %, more preferably up to 2 wt %, in each case based on the total amount of the solvent) of the aforementeioned organic solvent. Most preferred solvent is water.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i.e. compounds that impart a modified flowability to compositions, i.e. high viscosity under static conditions and low viscosity during agitation) are polysaccharides and organic and anorganic clays such as Xanthan gum (Kelzan®, CP Kelco, U.S.A.), methyl cellulose, Rhodopol® 23 (Rhodia, France), Veegum® (R.T. Vanderbilt, U.S.A.) or Attaclay® (Engelhard Corp., NJ, USA).

Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie). Examples for suitable anti-freezing agents are ethylene glycol, propylene glycol, urea and glycerol. Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof. Examples for tackifiers or binders are polyvinylpyrrolidons, polyvinylacetates, polyvinyl alcohols and cellulose ethers (Tylose®, Shin-Etsu, Japan).

The dispersion may comprises up to 70 wt % water, based on the weight of the dispersion. Usually, the dispersion comprises at least 10 wt % water, preferably at least 20 wt %, more preferably at least 30 wt %, and especially at least 40 wt %, based on the total weight of the dispersion.

The continuous phase comprises usually from 10 to 99.9 wt % water, preferably from 20 to 99.5 wt %, more preferably from 30 to 99.5 wt %, based on the weight of the continuous phase.

The dispersion comprises usually at least 5 wt % pesticide, preferably at least 10 wt %, more preferably at least 15 wt % and most preferably at least 20 wt %, based on the weight of the dispersion.

The dispersed phase comprises usually at least 25 wt % pesticide, preferably at least 40 wt %, more preferably at least 60 wt % and most preferably at least 70 wt %, based on the weight of the dispersed phase.

Usually, the dispersion comprises from 1 to 50 wt % amphiphile, preferably from 3 to 40 wt %, more preferably from 5 to 30 wt %, based on the total weight of the dispersion.

The dispersed phase comprises usually from 1 to 80 wt % amphiphile, preferably from 5 to 70 wt %, more preferably from 10 to 60 wt %, based on the weight of the dispersed phase.

Usually, the dispersion comprises from 0.1 to 20 wt % stabilizing surfactant, preferably from 0.5 to 12 wt %, more preferably from 2 to 8 wt %, based on the total weight of the dispersion.

The continuous phase comprises usually from 0.5 to 30 wt % stabilizing surfactant, preferably from 3 to 20 wt %, more preferably from 7 to 15 wt %, based on the weight of the continuous phase.

Usually, the dispersion comprises up to 50 wt % adjuvant, preferably from 3 to 30 wt %, more preferably from 7 to 25 wt %, based on the total weight of the dispersion.

The dispersion may comprises up to 10 wt % thickener, preferably 0.01 to 3 wt %, more preferably 0.1 to 1 wt %, based on the weight of the dispersion.

The present invention further relates to a method for preparing the dispersion according to the invention comprising a step of contacting the components. Suitable methods are:
The application of high-energy input, for example by ultrasonication, microfluidization, or homogenization.
A multistep premixing method including the formation of a dry lipid/stabilizer film and the application of mechanical stirring during the hydration of the dry film.
A dilution process (spontaneous formation) of lipids in the presence of ethanol.
The application of microfluidization followed by a heat treatment.
   Preferably, the method for preparing the dispersion according to the invention comprising a step of contacting the components under application of high-energy input, preferably in a shearing process. Usually, the method comprises a first step of preparing the continuous aqueous phase and the dispersed phase separately. In a second step, both phases are contacted under application of high-energy input.

The present invention also relates to a method for controlling phytopathogenic fungi and/or undesired plant growth and/or undesired attack by insects or mites and/or for regulating the growth of plants, where the dispersion according to the invention is allowed to act on the particular pests, their habitat or the plants to be protected from the particular pest, the soil and/or on undesired plants and/or the useful plants and/or their habitat. The dispersion may be used as such or solvents, such as water may be added prior to application to arrive at a concentration of pesticide, which is suitable for the desired amount of pesticide to be applied.

The method according to the invention are particularly important for various cultivated plants, such as cereals, e.g. wheat, rye, barley, triticale, oats or rice; beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, mustard, olives, sunflowers, coconut, cocoa beans, castor oil plants, oil palms, ground nuts or soybeans; cucurbits, such as squashes, cucumber or melons; fiber plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, sugar cane or oil palm; corn; tobacco; nuts; coffee; tea; bananas; vines (table grapes and grape juice grape vines); hop; turf; natural rubber plants or ornamental and forestry plants, such as flowers, shrubs, broad-leaved trees or evergreens, e.g. conifers; and on the plant propagation material, such as seeds, and the crop material of these plants.

The term “plant propagation material” is to be understood to denote all the generative parts of the plant such as seeds and vegetative plant material such as cuttings and tubers (e.g. potatoes), which can be used for the multiplication of the plant. This includes seeds, roots, fruits, tubers, bulbs, rhizomes, shoots, sprouts and other parts of plants, including seedlings and young plants, which are to be transplanted after germination or after emergence from soil. These young plants may also be protected before transplantation by a total or partial treatment by immersion or pouring. The term “cultivated plants” is to be understood as including plants which have been modified by breeding, mutagenesis or genetic engineering including but not limiting to agricultural biotech products on the market or in development. Genetically modified plants are plants, which genetic material has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e.g. by glycosylation or polymer additions such as prenylated, acetylated or farnesylated moieties or PEG moieties.

When employed in plant protection, the amounts of pesticide applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha. In treatment of plant propagation materials such as seeds, e.g. by dusting, coating or drenching seed, amounts of pesticide are of from 0.1 to 1000 g, preferably from 1 to 1000 g, more preferably from 1 to 100 g and most preferably from 5 to 100 g, per 100 kilogram of plant propagation material (preferably seed) are generally required. When used in the protection of materials or stored products, the amount of pesticide applied depends on the kind of application area and on the desired effect. Amounts customarily applied in the protection of materials are, e.g., 0.001 g to 2 kg, preferably 0.005 g to 1 kg, of active substance per cubic meter of treated material.

The user applies the dispersion according to the invention usually from a predosage device, a knapsack sprayer, a spray tank or a spray plane. Here, the dispersion is made up with water and/or buffer to the desired application concentration, it being possible, if appropriate, to add further auxiliaries, and the ready-to-use spray liquor or the agrochemical composition according to the invention is thus obtained. Usually, 50 to 500 liters of the ready-to-use spray liquor are applied per hectare of agricultural useful area, preferably 100 to 400 liters.

Advantages of the present invention are that it is based on aqueous system, that it contains a very low amount of organic solvent, and that it allows a high concentration of pesticide in the dispersion. The dispersion may comprise various polar or unpolar pesticides and even additional adjuvants. The dispersion is thermodynamically stable, which allows long storage time, even under changing temperatures. The pesticide has a high bioavailability. The dispersion may be distributed in concentration and diluted with water to prepare a ready to use tank mix. Such a dilution is possible with various amount of water without adverse effect on the inner structure of the dispersion. The viscosity (important for spray applications) may be adjusted by adding various amounts of water, again without adverse effect on the dispersion.

The invention is further illustrated but not limited by the following examples.

### EXAMPLES

Stabilizer A: α-ω-Hydroxy terminated triblock polymer (EO/PO/EO), water soluble, average mol weight 12000 to 14000.
Stabilizer B: Aqueuous composition containing 33 wt % comb polymer made of methacrylic acid, methyl methacrylate and methoxy polyethylene glycol methacrylate.
Monoglyceride: A monoglyceride comprising about 65% of monolinolein.
Adjuvant A: Hydrophobic fatty alcohol ethoxylate alkoxylate, liquid at room temperature, dynamic viscosity at 25° C. 70-80 mPas.
Adjuvant B: Fatty alcohol ethoxylate alkoxylate, liquid at room temperature, cloud point according to EN 1890 (1 g in 100 g water) 28-30° C., water solubility at least 10 wt % at room 20° C.

### Analytics:

To evaluate if the shearing process was successful the internally self-assembled dispersion was diluted with water as the dispersion according to the invention should be readily dilutable with water.

Dynamic light scattering (DLS) was used to determine the hydrodynamic radius (R_{H}) of the internally self-assembled particles. The equipment was composed of a goniometer and a diode laser (Coherent Verdi V5, λ=532 nm, Pmax=5 W) with single mode fiber detection optics (OZ from GMP, Zurich, Switzerland), an ALV/SO-SIPD/DUAL photomultiplier with pseudo cross correlation and an ALV 5000/E correlator with fast expansion (ALV, Langen, Germany). Measurements were carried out at a scattering angle of 90°. Concentrated dispersions are turbid. To avoid multiple scattering the dispersions were diluted at least to φ=10⁻³. Correlation functions were collected during at least 30 s and averaged 10 times. Size distributions were calculated from the averaged correlation functions using the inverse Laplace transformation.

Small angle X-ray scattering (SAXS) was used to characterize the internal nanostructure of the particles. The equipment comprised a SAXSess camera (Anton-Paar, Graz, Austria), connected to an Xray generator (Philips, PW 1730/10) operating at 40 kV and 50 mA with a sealed-tube Cu anode. A Gobel mirror was used to convert the divergent polychromatic X-ray beam into a focused line-shaped beam of monochromatic CuKa radiation (A=0.154 nm). The 2D scattering pattern was recorded by a PI-SCX fused fiber optic taper CCD Camera from Princeton Instruments, a division of Roper Scientific, Inc. (Trenton, N.J., USA), and integrated into the one-dimensional scattering function I(q). The CCD detector featured a 2084×2084 array with 24×24 μm pixel size (chip size: 50×50 mm) at a sample detector distance of 311 mm. The CCD was operated at −30° C. with a 10° C. water-assisted cooling to reduce the thermally generated charge. Cosmic ray correction and background subtraction were performed on the 2D image prior to further data processing. No sample background was subtracted. The temperature of the capillary and the metallic sample holder was controlled by a Peltier element. The dispersions were exposed to three 10-min periods of X-rays for averaging. The water-in-oil microemulsion shows a single broad correlation peak.

The pendant drop technique was used to determine the air-liquid surface tension σ of the internally self-assembled dispersion. The dispersion was prepared with CIPAC water D (342 ppm hardness) as described above. The concentrated dispersion was diluted with CIPAC water D according to the following concentrations: 0.1 wt % dispersion in CIPAC water D; 0.5 wt %; 1.0 wt %; 2.0 wt % and 5.0 wt %. The instrument used was the OCA 10 from dataphysics. In the experiment a drop as large as possible was generated at the tip of a needle by ejecting a defined sample volume (typically 1 μl). The shape of the drop was detected by a CCD camera as a function of time (1 picture per second) and analyzed using the Young-Laplace equation. The dynamic measurement was performed until the equilibrium value was reached.

### Example 1

### Step A) Preparation of the Dispersed Phase

0.75 g Monoglyceride was molten at around 50° C. and weighed in as liquid using a conventional pipette. 4.25 g fenpropimorph was weighed in accordingly. To ensure homogeneous mixing the dispersed phase was placed on a rotating shaker at least 2 times. Prior to the preparation of the raw-dispersion the dispersed phase was thermostated in a heating block at the shearing temperature.

### Step B) Preparation of the Aqueous Phase

To prepare the aqueous phase a 15 wt. % stock solution of Stabilizer A in water was produced to ensure that Stabilizer A was dissolved completely. To support the dissolution the stock solution was kept at 9° C. until use. For 5.0 g of dispersed phase 0.05 g Stabilizer A were added, i.e. 3.33 g of stock solution. The stock solution has to be diluted with 1.67 g of water to arrive at a total of 5.0 g of aqueous phase. After mixing the aqueous phase gently to avoid foam formation it was thermostated at the shearing temperature.

### Step C): Preparation of the Raw-Dispersion

Prior to the shearing process a total of 10 g of raw dispersion was prepared as follows: The aqueous phase and the dispersed phase (both 5.0 g) were weighed into glass vessels sealed with a screw cap and thermostated separately at the shearing temperature of 40° C. To prepare the raw-dispersion the dispersed phase was poured into the aqueous phase and dispersed with a heated spatula. The raw-dispersion was then sheared immediately.

### Step D) Shearing Process

The raw dispersion was immediately sheared mechanically through the shearing device based on Couette geometry. The shear rate was kept constant at 15.000 s⁻¹, the shearing device was preheated to 40° C. The raw dispersion was poured into the top opening of the shearing device and sheared as fast as possible through the narrow gap between the rotor and the stator. The internally self-assembled dispersion was collected from the outlet at the bottom of the shear cell.

### Examples 2-9

The total composition of examples 1 to 9 is given in Table 1. All dispersions were prepared as in Example 1 in a total amount of 10.0 g.

The pesticide was fenpropimorph in examples 1, 2, 6, 7 and 8, pyraclostrobin in example 3, and prochloraz in examples 4, 5 and 9.

The amphiphil was Monoglyceride in examples 1-3, and 6, and phytantriol in examples 4, 5, and 7-9.

The stabilizing surfactant (“Stabilizer”) was Stabilizer A in examples 1-5, 8 and 9, or Stabilizer B in examples 6 and 7.

Regarding Example 5: In contrast to fenpropimorph, prochloraz is an amorphous solid at room temperature. To prepare the dispersed phase, 4.8 g prochloraz and 1.2 g phytantriol were weighed into a glass vessel and sealed. The mixture was thermostated well above the melting temperature of prochloraz (48° C.) until prochloraz was molten. The mixture was homogenized on a rotating shaker several times. To increase the viscosity of the aqueous phase at higher temperatures methylcellulose (Methocel® A4C, 27.5-31.5 methoxyl content, viscosity 12-18 cps as 2 wt % solution in water) was added prior to the preparation of the raw dispersion. To ensure complete dissolution of methylcellulose a stock-solution was prepared and stored at 9° C. for 2 days. The stock solution was then added to the aqueous phase.

TABLE 1
Composition of examples 1-9 (all amounts are given in gram)

| Example | 1 | 2 | 3 ^{e)} | 4 ^{e)} | 5 | 6 | 7 | 8 | 9 |
|---|---|---|---|---|---|---|---|---|---|
| Pesticide | 4.25 | 4.25 | 1.5 | 3.0 | 4.8 | 4.25 | 4.8 | 4.8 | 4.4 |
| Amphiphil | 0.75 | 0.75 | 2.5 | 0.9 | 1.2 | 0.75 | 1.2 | 1.2 | 1.1 |
| Adjuvant A ^{a)} | — | — | 1.0 | 2.1 | — | — | — | — | — |
| Water | 4.95 | 4.1 | 4.95 | 3.952 | 3.928 | 4.95 | 3.952 | 2.654 | 3.282 |
| Stabilizer | 0.05 | 0.05 | 0.05 | 0.048 | 0.048 | 0.05 | 0.048 | 0.05 | 0.044 |
| Glycerol ^{b)} | — | 0.85 | — | — | — | — | — | 0.696 | — |
| Methyl cellolose | — | — | — | — | 0.024 | — | — | — | 0.024 |
| Adjuvant B ^{b)} | — | — | — | — | — | — | — | 0.6 | 0.65 |
| R_{H} [nm] | 450 | 500 | — | — | 680 | 60 | 56 | 180 | — |
| Tension σ [mN/m] ^{c)} | 32.5 | — | — | — | — | 33 | 29 | — | — |

^{a)} added in step A) to the dispersed phase;
^{b)} added to dispersion after shearing process;
^{c)} air-liquid surface tension σ;
^{e)} shearing process was carried out at 70° C.

### Example 10

### Biological Evaluation of Fenpropimorph Formulations

Various Fenpropimorph samples were tested for their curative activity on brown rust in wheat in greenhouse trials in concentrations of 1600, 800 and 200 ppm in comparison to an emulsion concentrate (EC) of fenpropimorph (750 g/l active, in cyclohexanon, commercially available as Corbel® from BASF SE). Without treatment the infection was in the range of 90%. 7 days after treatment the infected area of wheat leaves was assessed. The results are summarized in the table below.

| | Brown rust on wheat, infected area, % | | |
|---|---|---|---|
| Sample | 200 ppm | 800 ppm | 1600 ppm |
| EC formulation Corbel ® | 70 | 3 | 0 |
| Sample of Example 1 | 68 | 4 | 0 |
| Sample of Example 8 | 65 | 5 | 0 |

* Concentration of Fenpropimorph in applied spray solution

### Example 11

### Biological Evaluation of Prochloraz Formulations

Various Prochloraz samples were tested for their curative activity on netblotch in barley in greenhouse trials in concentrations of 2250, 563 and 141 ppm in comparison to an emulsion concentrate (EW) of prochloraz (450 g/l active, with 12-13 wt % o-sec-butylphenol and 4-4 wt % solvent naphtha, commercially available as Sportak® 45 EW from BASF SE). Without treatment the infection was in the range of 48%. 7 days after treatment the infected area of barley leaves was assessed. The results are summarized in the table below.

| | Netblotch on barley, infected area, % | | |
|---|---|---|---|
| Sample | 141 ppm | 563 ppm | 2250 ppm |
| EW formulation Sportak ® | 28 | 20 | 13 |
| Sample of Example 4 | 27 | 17 | 11 |
| Sample of Example 5 | 27 | 17 | 12 |
| Sample of Example 9 | 23 | 12 | 9 |

* Concentration of Prochloraz in applied spray solution

1-13. (canceled)

14. A dispersion containing an aqueous continuous phase and a dispersed phase, wherein the dispersed phase exhibits a nano-sized self-assembled structurization and wherein the dispersed phase contains a pesticide with a water solubility at 25° C. of up to 10 g/l and a melting point of below 100° C.

15. The dispersion of claim 14, wherein the dispersion comprises at least 5 wt % pesticide, based on the weight of the dispersion.

16. The dispersion of claim 14, wherein the dispersed phase comprises at least 25 wt % pesticide, based on the weight of the dispersed phase.

17. The dispersion of claim 14, wherein the dispersion comprises at least 10 wt % water, based on the weight of the dispersion.

18. The dispersion of claim 14, wherein the dispersion comprises from 1 to 50 wt % of an amphiphile, based on the weight of the dispersion.

19. The dispersion of claim 14, wherein the dispersed phase comprises an amphiphile, which is an amphiphilic lipid, a polyethylene oxide amphiphile, and/or a urea-based amphiphile.

20. The dispersion of claim 14, wherein the dispersion comprises from 0.1 to 20 wt % of a stabilizing surfactant, based on the weight of the dispersion, wherein the stabilizing surfactant is selected from the group consisting of anionic, cationic, nonionic and amphoteric surfactants, block polymers, polyelectrolytes, polysaccharide, and mixtures thereof.

21. The dispersion of claim 14, wherein the continuous phase comprises a stabilizing surfactant, which is a nonionic surfactant and/or a block polymer.

22. The dispersion of claim 14, wherein the internally nanostructured dispersed phase has a signal in small angle X-ray scattering.

23. The dispersion of claim 14, wherein the continuous phase contains a thickener.

24. The dispersion of claim 14, wherein the dispersion comprises up to 50 wt % adjuvant, based on the total weight of the dispersion.

25. A method for preparing the dispersion of claim 14, comprising a step of contacting the components.

26. A method for controlling phytopathogenic fungi and/or undesired plant growth and/or undesired attack by insects or mites and/or for regulating the growth of plants, comprising allowing the dispersion of claim 14 to act on the particular pests, their habitat or the plants to be protected from the particular pest, the soil and/or on undesired plants and/or the useful plants and/or their habitat.

27. The method of claim 26, wherein the dispersion comprises at least 5 wt % pesticide, based on the weight of the dispersion.

28. The method of claim 27, wherein the dispersed phase comprises at least 25 wt % pesticide, based on the weight of the dispersed phase.

29. The method of claim 28, wherein the dispersion comprises at least 10 wt % water, based on the weight of the dispersion.

30. The method of claim 29, wherein the dispersion comprises from 1 to 50 wt % of an amphiphile, based on the weight of the dispersion.

31. The method of claim 30, wherein the dispersed phase comprises an amphiphile, which is an amphiphilic lipid, a polyethylene oxide amphiphile, and/or a urea-based amphiphile.

32. The method of claim 31, wherein the dispersion comprises from 0.1 to 20 wt % of a stabilizing surfactant, based on the weight of the dispersion, wherein the stabilizing surfactant is selected from the group consisting of anionic, cationic, nonionic and amphoteric surfactants, block polymers, polyelectrolytes, polysaccharide, and mixtures thereof.

33. The method of claim 32, wherein the continuous phase comprises a stabilizing surfactant, which is a nonionic surfactant and/or a block polymer.

34. The method of claim 31, wherein the internally nanostructured dispersed phase has a signal in small angle X-ray scattering.

35. The method of claim 34, wherein the continuous phase contains a thickener.

36. The method of claim 35, wherein the dispersion comprises up to 50 wt % adjuvant, based on the total weight of the dispersion.
